(19) United States
(12) Patent Application Publication
(10) Pub. No.: US 2014/0355602 A1
(43) Pub. Date: Dec. 4, 2014

(54) Dynamic Multicast State Aggregation In Transport Networks

(71) Applicant: Avaya Inc., Basking Ridge, NJ (US)

(72) Inventor: Srikanth Keesera, Tewksbury, MA (US)

(21) Appl. No.: 13/906,662

(22) Filed: May 31, 2013

(51) Int. Cl. H04L 12/761

(52) U.S. Cl. CPC H04L 45/16
USPC 370/390

(57) ABSTRACT

A method, apparatus and computer program product for providing dynamic multicast state aggregation in transport networks is presented. An ingress sender node and a set of egress receiver nodes for each of a plurality of multicast streams within a network are identified and assigned a unique address. This unique same address is used in the forwarding table in the core of the network for any set of multicast streams that traverse the network from the same ingress sender node to the same set of egress receiver nodes.

### BACKGROUND

Data communications networks have become ubiquitous. A typical data communication networks may include various computers, servers, nodes, routers, switches, hubs, proxies, and other devices coupled to and configured to pass data to one another. These devices are referred to herein as “network elements,” and may provide a variety of network resources on a network. Data is communicated through data communication networks by passing protocol data units (such as packets, cells, frames, or segments) between the network elements over communication links on the network. A particular protocol data unit may be handled by multiple network elements and cross multiple communication links as it travels between its source and its destination over the network.

A typical network arrangement includes a transport network used between access networks. The transport network typically provides some type of encapsulation within its core for transporting data across the transport network. One type of transport network is known as a Shortest Path Bridging (SPB) network. When used with Mac-In-Mac encapsulation the network may be referred to as a Shortest Path Bridging Multicast (SPBM) network. For this application the two terms SPB and SPBM are used interchangeably. SPB technology provides logical Ethernet networks on native Ethernet infrastructures using a link state protocol to advertise both topology and logical network membership. Packets are encapsulated at the edge either in Media Access Control (MAC)-in-MAC 802.1ah and transported only to other members of the logical network. Unicast and multicast are supported and all routing is on symmetric shortest paths. Many equal cost shortest paths are supported.

SPB uses Intermediate System to Intermediate System (ISIS) as the control protocol to transfer routing information between devices in an SPB Network acting as a transport network between access networks which may be running different protocols. In an SPB network, the ISIS Link State Database (LSDB) is used to advertise routing information. In addition to information about adjacencies with other SPB enabled devices the LSDB also includes reachability information for services outside the SPB network. Examples are—IPv4 unicast routes, IPv4 Multicast Routes, IPv6 unicast routes, IPv6 multicast routes, L2 Virtual Service networks (VSNs), Unicast Backbone Media Access Control (BMAC) addresses etc.

### SUMMARY

Conventional mechanisms such as those explained above suffer from a variety of deficiencies. The performance and scalability of multicast traffic has traditionally been a sore point for data networks. The range of problems encountered with multicast range from complex stream discovery mechanisms, poor scaling (resulting from either sub-optimal designs or lack of aggregation), slower convergence (resulting from either sub-optimal designs or lack of aggregation), and dependency of multicast routing protocols on other unicast protocols

As part of evolution of SPBM networks to support multicast services almost all of these issues have either been completely addressed or mitigated. The one issue that has not completely been solved as part of that effort has been the lack of aggregation capabilities around multicast state. While the SPB Multicast solution improved scaling and convergence times significantly—the size of the multicast forwarding tables in the core of the network still maintain a direct correlation to the sum of all edge multicast forwarding table sizes.

This direct correlation is a problem for a couple of reasons. A multicast overload condition in the edge could impact the stability of the core network. When there are really large numbers of flows in the network—a large core forwarding table size means that the service restoration times in the event of core link/node up/down is not completely under the control of the core network operator. This makes it difficult to guarantee predictable service restoration times. What is needed is a solution that breaks the direct correlation between the number of access multicast flows and the size of the multicast forwarding table in the core of the network

Embodiments of the invention significantly overcome such deficiencies and provide mechanisms and techniques that provide multicast state aggregation by exploiting the statistical grouping multicast traffic paths in a network.

In a particular embodiment of a method for providing a dynamic multicast state aggregation in transport networks the method begins with identifying an ingress sender node and a set of egress receiver nodes for each of a plurality of multicast streams within a network. The method further includes using a same address in the forwarding table in the core of the network for any set of multicast streams that traverse the network from the same ingress sender node to the same set of egress receiver nodes.

Other embodiments include a computer readable medium having computer readable code thereon for providing dynamic multicast state aggregation in transport networks. The computer readable medium includes instructions for identifying an ingress sender node and a set of egress receiver nodes for each of a plurality of multicast streams within a network. The computer readable medium further includes instructions for using a same address in the forwarding table in the core of the network for any set of multicast streams that traverse the network from the same ingress sender node to the same set of egress receiver nodes.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that dynamic multicast state aggregation in transport networks as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing dynamic multicast state aggregation in transport networks as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Avaya, Inc. of Basking Ridge, N.J.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 depicts a block diagram of a transport network having several multicast streams;

FIG. 2 shows an Egress Node Group table for the network of FIG. 1;

FIG. 3 shows a first Edge Multicast Table for the network of FIG. 1;

FIG. 4 shows a second Edge Multicast Table for the network of FIG. 1;

FIG. 5A shows a Core Multicast Table;

FIG. 5B shows a Tunnel-DA Table for an SPB Network;

FIG. 6 shows a flow diagram for a first particular embodiment of a method for providing dynamic multicast state aggregation in transport networks in accordance with embodiments of the invention;

FIG. 7 shows a flow diagram for a second particular embodiment of a method for providing dynamic multicast state aggregation in transport networks in accordance with embodiments of the invention; and

FIG. 8 illustrates an example ingress node architecture for a computer system that performs dynamic multicast state aggregation in transport networks in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

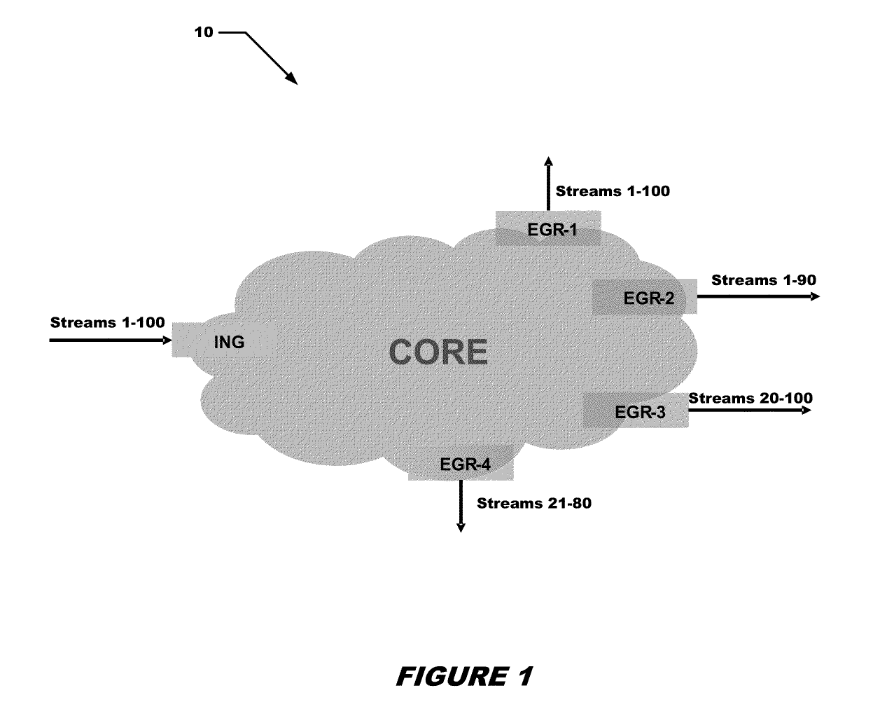

Referring to FIG. 1, a block diagram of a transport network environment 10 is shown. Transport network environment 10 includes a core network, an ingress node (ING), and four egress nodes (EGR-1, EGR-2, EGR-3, EGR-4). While only a single ingress node and four egress nodes are shown, it should be understood that any number of ingress and egress nodes may be used. Also shown are a plurality of multicast streams. Streams 1-100 enter the core network by way of ingress node ING. Streams 1-100 exit the core network by way of egress node EGR-1. Streams 1-90 exit the core network by way of egress node EGR-2. Streams 21-100 exit the core network by way of egress node EGR-3. Streams 21-80 exit the core network by way of egress node EGR-3. Without implementing the presently described method and apparatus for providing dynamic multicast state aggregation in transport networks, the core network needs to maintain 100 different multicast forwarding records, one for each stream.

When the presently described method and apparatus for providing dynamic multicast state aggregation in transport networks is implemented in the transport network environment of FIG. 1, then for each node having ingressing multicast streams that egress at one or more other nodes, the following steps are performed.

For each of a plurality of multicast steams within a network, an ingress sender node and a set of egress receiver nodes are identified. For any set of multicast streams that traverse the network from the same ingress sender node to the same set of egress receiver nodes, a same address is assigned, and this address is used in the forwarding table in the core of the network. This is typically a many to one assignment, since it is quite likely that more than one multicast stream egresses an identical set of nodes. The traffic for each is then encapsulated in a transport network header where the destination address is determined as described above for that stream.

A set of multicasts tree can be built. A first tree for streams 1-20 which lead to EGR-1 and EGR-2; a second tree for streams 21-80 which lead to EGR-1, EGR-2, EGR-3 and EGR-4; a third tree for streams 81-90 which lead to EGR-1, EGR-2 and EGR-3, and a fourth tree which leads to EGR-1 and EGR-3. As a result, the core network only has to maintain four multicast records instead of 100.

As a further example, suppose stream 20 joined EGR-4. A new multicast tree (a fifth tree) would be created for stream 20 leading to EGR-4. Now only five records need be maintained.

The transport network uses a routing protocol to communicate stream presence and receiver interest between ingress and egress nodes. In a more specific embodiment the core network is a Shortest Path Bridging (SPB) network. The SPB IP Multicast protocol methods are employed to communicate between ingress and egress nodes and the transport multicast destination address is a Backbone Media Access Control (BMAC) address where the BMAC address is made up of the nickname of the ingress node and an Intermediate System Identifier (I-SID) dynamically allocated by the ingress node.

The ingress node requests the construction of the multicast tree by listing an I-SID and the list of system-id values of the egress nodes (or list of SPB nicknames of the egress nodes) using an ISIS TLV. The interpretations and computation in the core node interprets this TLV and builds the shortest path tree rooted at the ingress node and leading to the egress nodes.

For the network environment shown in FIG. 1, this would result in the following multicast trees being built:

Tree 1 for streams 1-20 {EGR-1, EGR-2}, BMAC_DA=(nickname—ingress-1, I-SID-1);

Tree 2 for streams 21-80 {EGR-1, EGR-2, EGR-3, EGR-4}, BMAC_DA=(nickname—ingress-1, I-SID-2);

Tree 3 for streams 81-90 {EGR-1, EGR-2, EGR-3}, BMAC_DA=(nickname—ingress-1, I-SID-3); and

Tree 4 for streams 91-100 {EGR-1, EGR-3}, BMAC_DA=(nickname—ingress-1, I-SID-4).

Here, the core network has to maintain only four multicast BMAC records instead of 100.

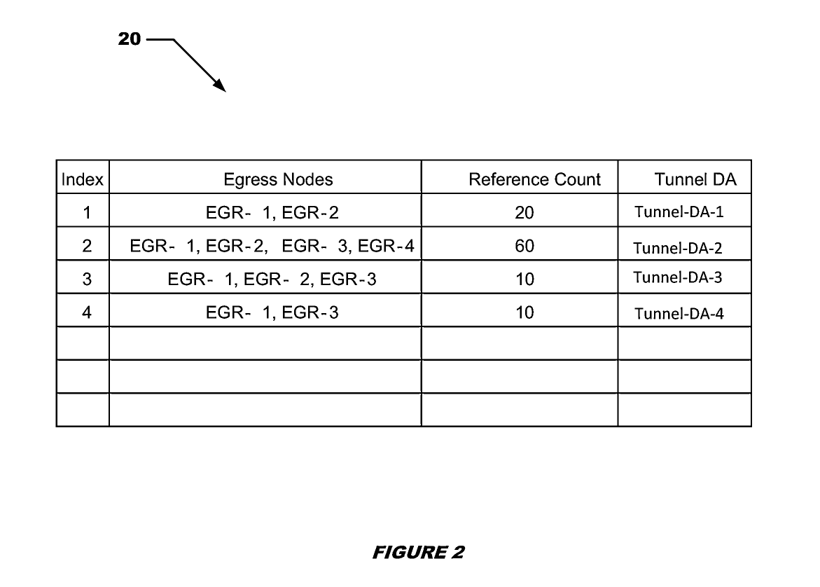

Referring now to FIG. 2 the Egress Node Group table shows the grouping of the streams into four groups. The first group includes egress nodes EGR-1 and EGR-2, for 20 streams, using a tunnel Destination Address (DA) of I-SID-1. The second group includes egress nodes EGR-1, EGR-2, EGR-3 and EGR-4, for 60 streams, using a tunnel Destination Address (DA) of I-SID-2. The third group includes egress nodes EGR-1, EGR-2 and EGR-3, for 10 streams, using a tunnel Destination Address (DA) of I-SID-3. The fourth group includes egress nodes EGR-1 and EGR-3, for 10 streams, using a tunnel Destination Address (DA) of I-SID-4.

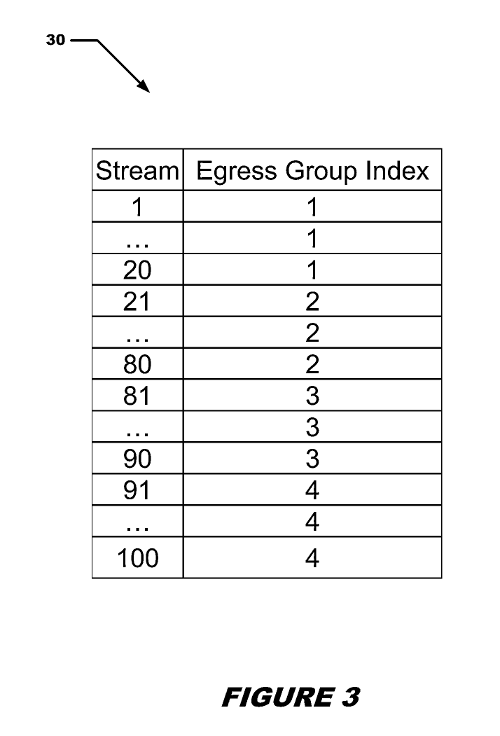

FIG. 3 shows an Edge Multicast Table showing an Egress Group Index for each stream. If a new egress node joins a stream or an existing egress node leaves the stream, the row corresponding to stream is updated to use a different Egress Group Index. In this case only one record needs to be updated.

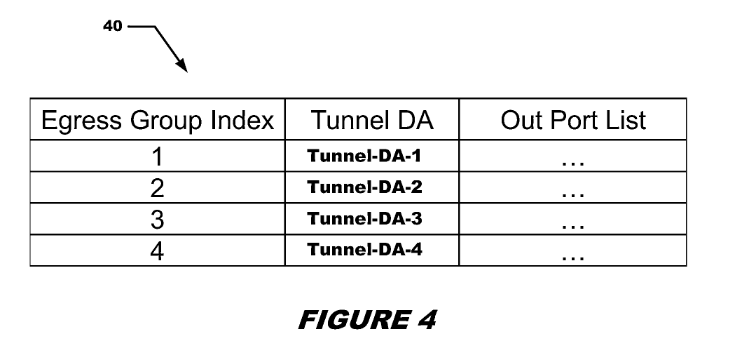

FIG. 4 shows another Edge Multicast Table showing an Egress Group Index, a tunnel destination address and an out port list. If the topology changes due to a link going up or down, a node going up or down, and the like, only this small table needs to be updated. The number of updates is independent of the number of streams, and is only dependent on the statistical grouping of Egress nodes for different streams.

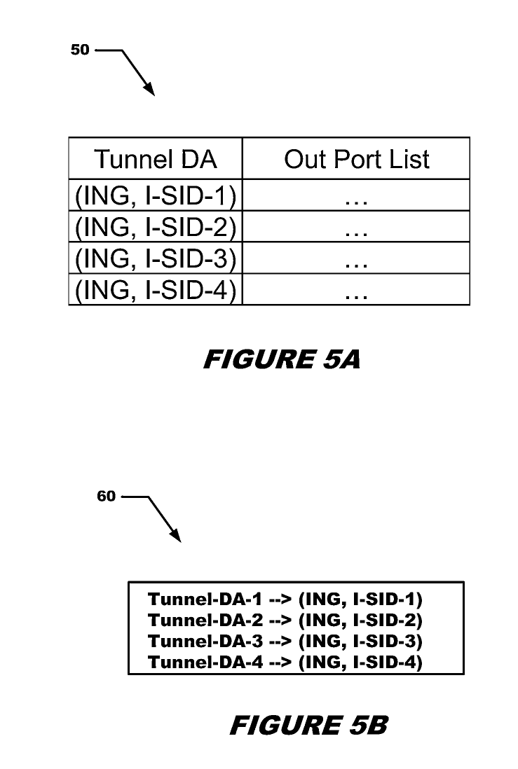

FIG. 5A shows the Core Multicast Table. This table correlates the tunnel destination address with the out port list. If the topology changes due to a link going up or down, a node going up or down, and the like, only this small table needs to be updated. The number of updates is independent of the number of streams, and is only dependent on the statistical grouping of Egress nodes for different streams. FIG. 5B shows a Tunnel-DA Table for an SPB Network.

The presently described method and apparatus for providing multicast state aggregation in transport networks provides several advantages as compared to conventional transport networks. The present invention exploits the statistical aggregation that occurs in multicast networks and provides traffic flows that are always optimal (e.g., with no Egress drops). The forwarding table size is never greater than the number of flows. In most common multicast deployments—the forwarding table size on the core is much smaller than the number of flows. The present invention also provides predictable core convergence times, with fewer records to update when core topology changes occur. Further, the present invention is dynamic in nature, with no user configuration or intervention needed.

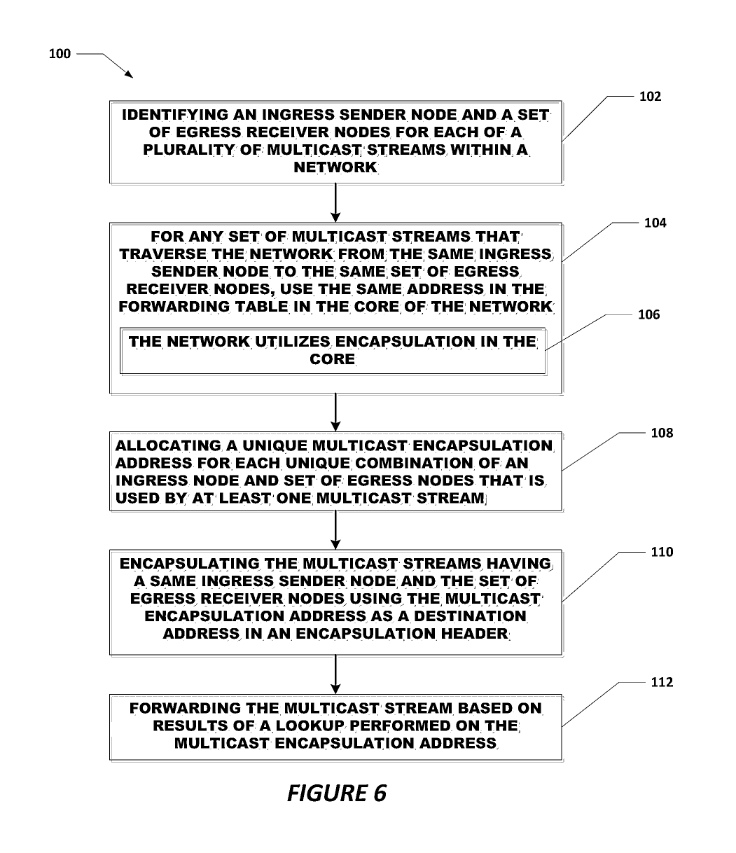

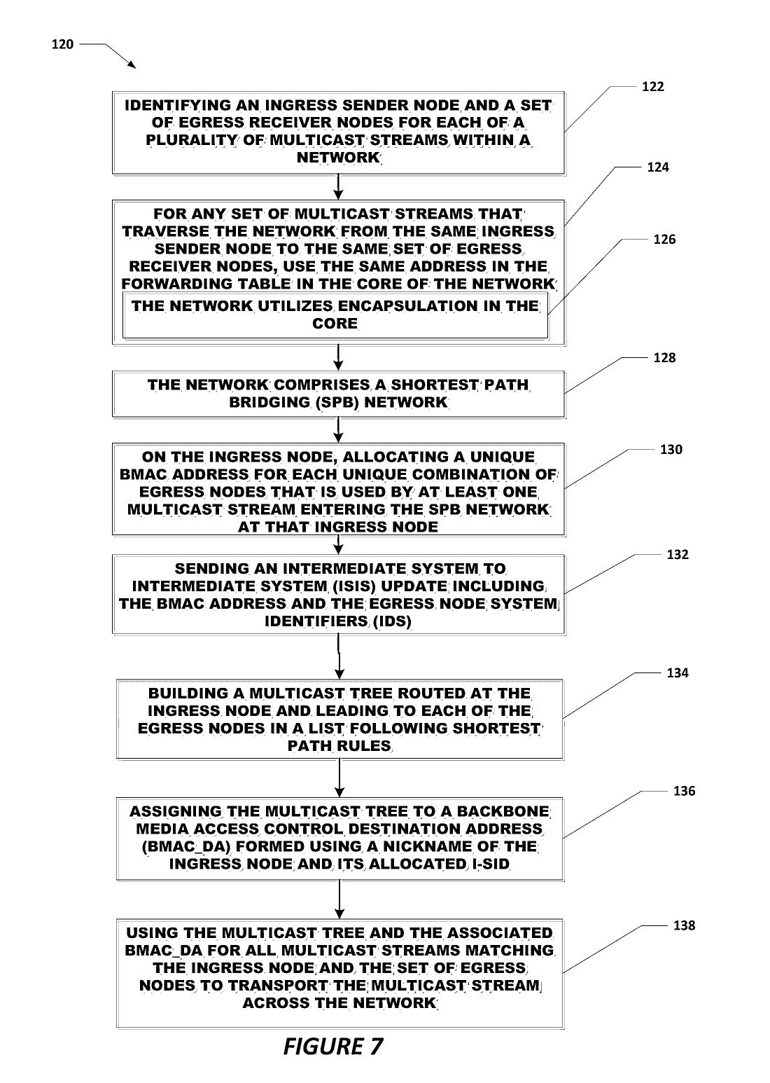

Flow charts of particular embodiments of the presently disclosed method are depicted in FIGS. 6 and 7. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 6 a first particular embodiment of a method for providing dynamic multicast aggregation in transport networks is shown. Method 100 begins with processing block 102 which discloses identifying an ingress sender node and a set of egress receiver nodes for each of a plurality of multicast streams within a network. The network is a transport network.

Processing block 104 states for any set of multicast streams that traverse the network from the same ingress sender node to the same set of egress receiver nodes, use the same address in the forwarding table in the core of the network. As shown in processing block 106 the network utilizes encapsulation in the core. An example is shown in FIG. 1 wherein 100 multicast streams are split amongst four egress nodes, each receiving a different set of streams.

Processing block 108 recites allocating a unique multicast encapsulation address for each unique combination of an ingress node and set of egress nodes that is used by at least one multicast stream. Referring back to FIG. 1, this would result in four Multicast Encapsulation Addresses being used for all 100 multicast streams.

Processing block 110 discloses encapsulating the multicast streams having a same ingress sender node and set of egress receiver nodes using the Multicast Encapsulation Address as a destination address in an encapsulation header. Processing block 112 states forwarding the multicast stream based on results of a lookup performed on the Multicast Encapsulation Address.

Referring now to FIG. 7 a second particular embodiment of a method for providing dynamic multicast aggregation in transport networks is shown. Method 120 begins with processing block 122 which discloses identifying an ingress sender node and a set of egress receiver nodes for each of a plurality of multicast streams within a network. The network is a transport network. An example is shown in FIG. 1 wherein 100 multicast streams are split amongst four egress nodes, each receiving a different set of streams.

Processing block 124 states for any set of multicast streams that traverse the network from the same ingress sender node to the same set of egress receiver nodes, use the same address in the forwarding table in the core of the network. As shown in processing block 126 the network utilizes encapsulation in the core. As further shown in processing block 128, the network comprises a Shortest Path Bridging Network.

Processing block 130 discloses on the ingress node, allocating a unique BMAC address for each unique combination of egress nodes that is used by at least one multicast stream entering the SPB network at that ingress node. Processing block 132 recites sending an Intermediate System to Intermediate System (ISIS) update including the BMAC address and the egress node system Identifiers (IDs).

Processing continues with processing block 134 which discloses building a multicast tree routed at the ingress node and leading to each of the egress nodes in a list following shortest path rules. Processing block 136 states assigning the multicast tree to a Backbone Media Access Control Destination Address (BMAC_DA) formed using a nickname of the ingress node and it's allocated I-SID. Processing block 136 recites using the multicast tree and the associated BMAC_DA for all multicast streams matching the ingress node and the set of egress nodes to transport the multicast stream across the network.

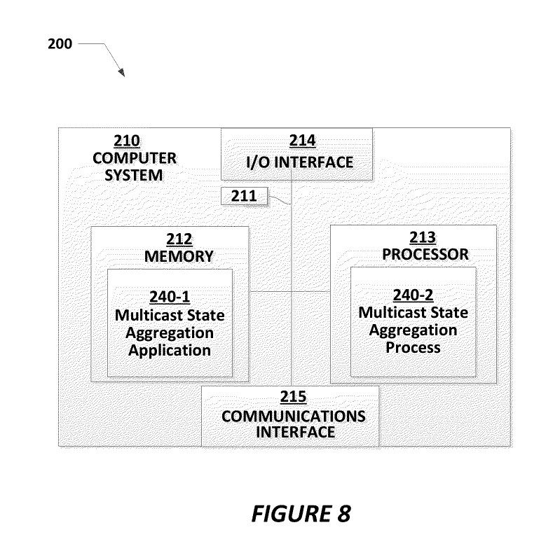

FIG. 8 is a block diagram illustrating example architecture of an egress node, also referred to herein as a computer system 210 that executes, runs, interprets, operates or otherwise provides multicast state aggregation in transport networks operating application 240-1 and multicast state aggregation operating process 240-2 suitable for use in explaining example configurations disclosed herein. The computer system 210 may be any type of computerized device.

As shown in this example, the computer system 210 includes an interconnection mechanism 211 such as a data bus or other circuitry that couples a memory system 212, a processor 213, an input/output interface 214, and a communications interface 215. The communications interface 215 enables the computer system 210 to communicate with other devices (i.e., other computers) on a network (not shown).

The memory system 212 is any type of computer readable medium, and in this example, is encoded with a multicast state aggregation operating application 240-1 as explained herein. The multicast state aggregation operating application 240-1 may be embodied as software code such as data and/or logic instructions (e.g., code stored in the memory or on another computer readable medium such as a removable disk) that supports processing functionality according to different embodiments described herein. During operation of the computer system 210, the processor 213 accesses the memory system 212 via the interconnect 211 in order to launch, run, execute, interpret or otherwise perform the logic instructions of a multicast state aggregation operating application 240-1. Execution of a multicast state aggregation operating application 240-1 in this manner produces processing functionality in the multicast state aggregation operating process 240-2. In other words, the multicast state aggregation operating process 240-2 represents one or more portions or runtime instances of a multicast state aggregation operating application 240-1 (or the entire a multicast state aggregation operating application 240-1) performing or executing within or upon the processor 213 in the computerized device 210 at runtime.

It is noted that example configurations disclosed herein include the multicast state aggregation operating application 240-1 itself (i.e., in the form of un-executed or non-performing logic instructions and/or data). The multicast state aggregation operating application 240-1 may be stored on a computer readable medium (such as a floppy disk), hard disk, electronic, magnetic, optical, or other computer readable medium. A multicast state aggregation operating application 240-1 may also be stored in a memory system 212 such as in firmware, read only memory (ROM), or, as in this example, as executable code in, for example, Random Access Memory (RAM). In addition to these embodiments, it should also be noted that other embodiments herein include the execution of a multicast state aggregation operating application 240-1 in the processor 213 as the multicast state aggregation operating process 240-2. Those skilled in the art will understand that the computer system 210 may include other processes and/or software and hardware components, such as an operating system not shown in this example.

During operation, processor 213 of computer system 200 accesses memory system 212 via the interconnect 211 in order to launch, run, execute, interpret or otherwise perform the logic instructions of the multicast state aggregation application 240-1. Execution of multicast state aggregation application 240-1 produces processing functionality in multicast state aggregation process 240-2. In other words, the multicast state aggregation process 240-2 represents one or more portions of the multicast state aggregation application 240-1 (or the entire application) performing within or upon the processor 213 in the computer system 200.

It should be noted that, in addition to the multicast state aggregation process 240-2, embodiments herein include the multicast state aggregation application 240-1 itself (i.e., the un-executed or non-performing logic instructions and/or data). The multicast state aggregation application 240-1 can be stored on a computer readable medium such as a floppy disk, hard disk, or optical medium. The multicast state aggregation application 240-1 can also be stored in a memory type system such as in firmware, read only memory (ROM), or, as in this example, as executable code within the memory system 212 (e.g., within Random Access Memory or RAM).

In addition to these embodiments, it should also be noted that other embodiments herein include the execution of multicast state aggregation application 240-1 in processor 213 as the multicast state aggregation process 240-2. Those skilled in the art will understand that the computer system 200 can include other processes and/or software and hardware components, such as an operating system that controls allocation and use of hardware resources associated with the computer system 200.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer-implemented method in which a computer system performs operations comprising:
identifying an ingress sender node and a set of egress receiver nodes for each of a plurality of multicast streams within a network; and
for any set of multicast streams that traverse said network from the same ingress sender node to the same set of egress receiver nodes, use a same address in the forwarding table in the core of said network.

2. The method of claim 1 wherein said network utilizes encapsulation in said core.

3. The method of claim 2 further comprising allocating a unique Multicast Encapsulation Address for each unique combination of an ingress node and set of egress nodes that is used by at least one multicast stream.

4. The method of claim 3 further comprising encapsulating said multicast streams having a same ingress sender node and said set of egress receiver nodes using said Multicast Encapsulation Address as a destination address in an encapsulation header.

5. The method of claim 4 further comprising forwarding said multicast stream based on results of a lookup performed on said Multicast Encapsulation Address.

6. The method of claim 1 wherein said network comprises a Shortest Path Bridging (SPB) Network.

7. The method of claim 6 further comprising allocating a unique Backbone Media Access Control (BMAC) address for each said ingress sender node and said set of egress receiver nodes that is used by at least one multicast stream.

8. The method of claim 7 further comprising sending an Intermediate System to Intermediate System (ISIS) update including said BMAC address and said egress node system Identifiers (IDs).

9. The method of claim 8 further comprising building a multicast tree routed at said ingress node and leading to each of said egress nodes in a list following shortest path rules.

10. The method of claim 9 further comprising assigning said multicast tree to a Backbone Media Access Control Destination Address (BMAC_DA) formed using a nickname of said ingress node and its allocated I-SID.

11. The method of claim 10 further comprising using said multicast tree and said associated BMAC_DA for all multicast streams matching said ingress node and said set of egress nodes to transport said multicast stream across said network.

12. A non-transitory computer readable storage medium having computer readable code thereon for providing multicast state aggregation in transport networks, the medium including instructions in which a computer system performs operations comprising:
identifying an ingress sender node and a set of egress receiver nodes for each of a plurality of multicast streams within a network; and
for any set of multicast streams that traverse said network from the same ingress sender node to the same set of egress receiver nodes, use a same address in the forwarding table in the core of said network.

13. The computer readable storage medium of claim 12 wherein said network utilizes encapsulation in said core.

14. The computer readable storage medium of claim 13 further comprising allocating a unique Multicast Encapsulation Address for each unique combination of an ingress node and set of egress nodes that is used by at least one multicast stream and encapsulating said multicast streams having a same ingress sender node and said set of egress receiver nodes using said Multicast Encapsulation Address as a destination address in an encapsulation header.

15. The computer readable storage medium of claim 14 further comprising forwarding said multicast stream based on results of a lookup performed on said Multicast Encapsulation Address.

16. The computer readable storage medium of claim 15 wherein said network comprises a Shortest Path Bridging (SPB) Network.

17. The computer readable storage medium of claim 16 further comprising allocating a unique Backbone Media Access Control (BMAC) address for each said ingress sender node and said set of egress receiver nodes that is used by at least one multicast stream and sending an Intermediate System to Intermediate System (ISIS) update including said BMAC address and said egress node system Identifiers (IDs).

18. The computer readable storage medium of claim 17 further comprising building a multicast tree routed at said ingress node and leading to each of said Egress nodes following shortest path rules and assigning said multicast tree to a Backbone Media Access Control Destination Address (BMAC_DA) formed using a nickname of said ingress node and its allocated I-SID.

19. The computer readable storage medium of claim 18 further comprising using said multicast tree and said associated BMAC_DA for all multicast streams matching said ingress node and said set of egress nodes to transport said multicast stream across said network.

20. A computer system comprising:
a memory;
a processor;
a communications interface;
an interconnection mechanism coupling the memory, the processor and the communications interface; and
wherein the memory is encoded with an application providing multicast state aggregation in transport networks, that when performed on the processor, provides a process for processing information, the process causing the computer system to perform the operations of:
identifying an ingress sender node and a set of egress receiver nodes for each of a plurality of multicast streams within a network; and
for any set of multicast streams that traverse said network from the same ingress sender node to the same set of egress receiver nodes, use a same address in the forwarding table in the core of said network.
